(19) United States
(12) Patent Application Publication
(10) Pub. No.: US 2026/0058517 A1
(43) Pub. Date: Feb. 26, 2026

(54) ELECTRIC WORK MACHINE AND METHOD FOR MANUFACTURING OUTER ROTOR MOTOR FOR USE IN ELECTRIC WORK MACHINE

(71) Applicant: MAKITA CORPORATION, Anjo-shi (JP)

(72) Inventors: Ryoto KAWAKAMI, Anjo-shi (JP); Hajime YAMAO, Anjo-shi (JP)

(73) Assignee: MAKITA CORPORATION, Anjo-shi (JP)

(21) Appl. No.: 19/304,233

(22) Filed: Aug. 19, 2025

(30) Foreign Application Priority Data
Aug. 22, 2024 (JP) 2024-141039

(51) Int. Cl. H02K 5/167; H02K 7/08; H02K 7/14; H02K 11/215; H02K 15/144; H02K 21/22

(52) U.S. Cl. CPC H02K 5/1675; H02K 7/085; H02K 7/145; H02K 11/215; H02K 15/144; H02K 21/22; H02K 2211/03

(57) ABSTRACT

An electric work machine in one aspect of the present disclosure includes an outer rotor motor and a power transmitting device. The outer rotor motor includes a rotor, a stator, a stator support, and a first bearing. The stator support (i) has a tubular shape including an inner peripheral surface, (ii) is inserted into a through hole of the stator, and (iii) fixes the stator by a first fixing mode, thereby supporting the stator. The first fixing mode is a mode in which (i) a screw fastener is not used and (ii) the stator support does not undergo a first deformation. The first deformation includes a deformation of the inner peripheral surface of the stator support based on the stator support fixing or having fixed the stator.

### CROSS-REFERENCE TO RELATED APPLICATIONS

The present application claims the benefit of Japanese patent application No. 2024-141039 filed with the Japan Patent Office on Aug. 22, 2024, and the entire disclosure of which is incorporated herein by reference.

### BACKGROUND

The present disclosure relates to an electric work machine equipped with an outer rotor motor.

The patent application publication No. 2023-005814 discloses an outer-rotor brushless motor. In this outer-rotor brushless motor, a stator and a bearing are fixed to a stator base.

### SUMMARY

As a method for fixing the stator to the stator base, it is conceivable to press-fit the stator onto the stator base. However, in this method, when the stator is press-fitted onto the stator base, the stator base may deform due to pressure exerted by the stator. If the stator base deforms, such a deformation may reduce the alignment accuracy of the axis of a bearing when the bearing is fixed to the stator base. The reduction in alignment accuracy of the bearing axis may shorten the bearing life and/or cause failure of the outer-rotor brushless motor.

It is desirable that one aspect of the present disclosure provides an electric work machine including an outer rotor motor in which a stator is properly fixed.

In the present disclosure, terms such as “first,” “second,” etc. are intended only to distinguish elements from one another and are not intended to limit the order or number of elements. Therefore, the first element may be referred to as the second element, and similarly, the second element may be referred to as the first element. In addition, the first element may be included without the second element, and similarly, the second element may be included without the first element.

One aspect of the present disclosure provides an electric work machine including an outer rotor motor and a power transmitting device (or a motive-power-transmitting part, or a transmission).

The outer rotor motor includes a rotor, a stator, a stator support, and a first bearing.

The rotor includes a rotor core and a shaft. The rotor core has a tubular shape and includes a magnet.

The stator is disposed within the rotor core. The stator includes a coil and a through hole. The shaft passes through the through hole.

The stator support (i) has a tubular shape including an inner peripheral surface, (ii) is inserted into the through hole, and (iii) fixes the stator by a first fixing mode, thereby supporting the stator. The first fixing mode is a mode in which (i) a screw fastener is not used and (ii) the stator support does not undergo a first deformation. The first deformation includes a deformation of the inner peripheral surface of the stator support based on the stator support fixing or having fixed the stator.

The first bearing (i) is fixed to the stator support inside the stator support and (ii) rotatably supports the shaft.

The power transmitting device is configured to transmit a rotation of the rotor to a driven tool to thereby drive the driven tool.

In the electric work machine thus configured, the stator can be properly fixed to the stator support.

Another aspect of this disclosure provides an electric work machine including an outer rotor motor and the power transmitting device. The outer rotor motor includes the rotor, the stator, and the stator support.

The stator support (i) has a tubular shape, (ii) is inserted into the through hole, and (iii) is bonded to the stator with an adhesive, thereby supporting the stator.

In the electric work machine thus configured, the stator can be properly fixed to the stator support.

Still another aspect of this disclosure provides a method for producing an outer rotor motor for use in an electric work machine.

This method includes fixing a stator to a stator support by a specified fixing mode. The stator support has a tubular shape. The fixing includes inserting the stator support into a through hole of the stator. The specified fixing mode is a mode in which (i) a screw fastener is not used and (ii) the stator support does not undergo a specified deformation. The specified deformation includes a deformation of an inner peripheral surface of the stator support based on fixing the stator to the stator support.

The method further includes inserting a bearing inside the stator support and fixing the bearing to the stator support. The bearing is configured to rotatably support a shaft of the rotor.

According to this method, the stator can be properly fixed to the stator support.

### BRIEF DESCRIPTION OF THE DRAWINGS

Example embodiments of the present disclosure are described hereinafter by way of example with reference to the accompanying drawings, in which:

FIG. 1 is a perspective view of an electric work machine in an embodiment;

FIG. 2 is a first perspective view of a motor and a controller in the electric work machine;

FIG. 3 is a first exploded perspective view of the motor;

FIG. 4 is a second perspective view of the motor;

FIG. 5 is a second exploded perspective view of the motor;

FIG. 6 is a cross-sectional view of the motor in a section parallel to the right and front directions of the motor and passing through a rotational axis AX;

FIG. 7 is an exploded perspective view of a stator base, a stator core, and a first bearing;

FIG. 8 is a front view of the stator core;

FIG. 9 is a cross-sectional view of the stator base, the stator core, and the first bearing in a section perpendicular to the rotational axis AX and passing through the first bearing;

FIG. 10A shows a first variation of the stator base and the stator core; and

FIG. 10B shows a second variation of the stator base and the stator core.

### DETAILED DESCRIPTION OF EXEMPLARY EMBODIMENTS

### 1. Overview of Embodiment

One embodiment may provide an electric work machine (or a power tool or electric machinery or on-site equipment) including at least any one of the following features.
Feature 1: an outer rotor motor.
Feature 2: the outer rotor motor includes a rotor.
Feature 3: the rotor includes a rotor core.
Feature 4: the rotor includes a shaft.
Feature 5: the rotor core has a tubular shape.
Feature 6: the rotor core includes a magnet (or magnets).
Feature 7: the outer rotor motor includes a stator.
Feature 8: the stator is disposed within the rotor core.
Feature 9: the stator includes a coil (or coils).
Feature 10: the stator includes a through hole. The shaft passes through (or penetrate through) the through hole.
Feature 11: the outer rotor motor includes a stator support.
Feature 12: the stator support has a tubular shape including an inner peripheral surface.
Feature 13: the stator support is inserted into the through hole.
Feature 14: the stator support fixes the stator by a first fixing mode, thereby supporting the stator.
Feature 15: the first fixing mode is a mode in which a screw fastener is not used.
Feature 16: the first fixing mode is a mode in which the stator support does not undergo a first deformation (or the first deformation does not occur).
Feature 17: the first deformation includes a deformation of the inner peripheral surface of the stator support.
Feature 18: the first deformation occurs or has occurred based on the stator support fixing or having fixed the stator. That is, the inner peripheral surface of the stator support does not undergo a deformation (or does not have a deformed portion) caused by fixing the stator to the stator support.
Feature 19: the outer rotor motor includes a first bearing.
Feature 20: the first bearing is fixed to the stator support inside (e.g., a hollow portion of or an internal space of) the stator support.
Feature 21: the first bearing rotatably supports the shaft.
Feature 22: a power transmitting device (or a power transmission mechanism or a power outputter or a power output mechanism or a driving mechanism or a driver) configured to transmit a rotation of the rotor to a driven tool (or a tool accessory) to thereby drive the driven tool.

In the electric work machine including at least features 1 through 22, the stator can be properly fixed to the stator support.

The stator support may fix the stator on an outer peripheral surface side of the stator support. The stator support may fix the first bearing on an inner peripheral surface side of the stator support.

The screw fastener has a screw groove (or a screw thread) formed in a spiral shape. Examples of the screw fastener include various screws, bolts, and nuts.

The first deformation may mean a deformation of the inner peripheral surface of the stator support from an initial state. The initial state is a state of the stator support before the stator is fixed to the stator support (i.e., a state in which the stator is separated from the stator support). The first deformation may be caused by the stator support receiving pressure from the stator when the stator is fixed to the stator support. The first deformation may include plastic deformation.

The first fixing mode may be a mode in which pressure is not applied to the stator support from the stator. Even if pressure is applied to the stator support from the stator, the first fixing mode may be a mode in which the inner peripheral surface of the stator support does not deform (or has not deformed) due to the pressure. The fixing by the first fixing mode may mean that the stator is fixed via the inner peripheral surface of the through hole of the stator. The stator support may support the stator using another structure, in a manner different from the fixing employed in the first fixing mode.

The stator support may support the stator without receiving pressure equal to or greater than a specified magnitude from the stator. In other words, the stator support may support the stator in a manner different from the manner in which the stator support receives pressure from the stator (that is, the pressure is applied to the stator).

The rotor may include an end that is open along the rotational axis of the rotor core. The stator may be inserted into the rotor from the end and positioned therein. The rotor may have a bowl shape.

The shaft may be directly or indirectly fixed to the rotor core, and may be configured to rotate integrally with the rotor core. The shaft may pass through the stator support. The shaft may be directly or indirectly coupled to the power transmitting device and may be configured to transmit a rotation of the shaft to the power transmitting device.

The first bearing may be in contact with the inner peripheral surface of the stator support. The first bearing may receive pressure from the inner peripheral surface of the stator support, thereby being supported by and fixed to the stator support.

The first bearing may be fixed to the stator support in any manner. The first bearing may be fixed in a manner similar to the first fixing mode. Specifically, the first bearing may be fixed to the stator support in a manner in which a deformation of the outer peripheral surface of the stator support does not occur based on the first bearing being fixed to the stator support. Alternatively, the first bearing may be fixed in a manner similar to a second fixing mode described below. Specifically, the first bearing may be fixed to the stator support in a manner in which a deformation of the outer peripheral surface of the stator support occurs based on the first bearing being fixed to the stator support. More specifically, for example, the first bearing is press-fitted into the stator support and fixed therein. In this case, the outer peripheral surface of the stator support may undergo a deformation occurred when the first bearing is press-fitted into the stator support.

One embodiment may include at least any one of the following features in addition to or in place of at least any one of the above Features 1 through 22.
Feature 23: the first bearing is fixed to the stator support by a second fixing mode.
Feature 24: the second fixing mode is a mode in which the stator support undergoes a second deformation (or the second deformation may occur, or the second deformation is likely to occur, or the second deformation is highly likely to occur).
Feature 25: the second deformation includes a deformation of the stator support based on the first bearing being fixed to or having been fixed to the stator support. That is, the stator support undergoes or may undergo a deformation (or the stator support has or may have a deformed portion) caused by fixing the first bearing to the stator support.

In the electric work machine including at least Features 1 through 25, the first bearing can be easily fixed to the stator support.

The second deformation may include a state in which the stator support deforms (or has deformed) as a result of the first bearing applying (or having applied) pressure to the inner peripheral surface of the stator support. The second deformation may occur in the process in which the first bearing is fixed to the stator support. The second deformation may include a deformation of the inner peripheral surface of the stator support. The second deformation may mean a deformation of the stator support (or a deformation of the inner peripheral surface of the stator support) from the initial state.

One embodiment may include at least any one of the following features in addition to or in place of at least any one of the above Features 1 through 25.
Feature 26: the second fixing mode includes a press-fit (or interference fit).

In the electric work machine including at least Features 1 through 26, the first bearing can be easily and stably fixed to the stator support.

The stator may be fixed to the stator support by a shrink fit (or shrink fitting by heating). The shrink fit may be performed as follows, for example. First, the stator is heated to expand the inner diameter of the through hole. Next, the stator support is inserted through the through hole. Then, the temperature of the stator is lowered to the room temperature, thereby shrinking the inner diameter of the through hole compared to its size during heating. This causes the stator support to apply pressure to the inner peripheral surface of the through hole (i.e., a stator inner peripheral surface as described below), and the stator is fixed to the stator support.

The stator may be fixed to the stator support by a freezing fit (or cooling fit, or shrink fitting using cooling). The freezing fit may be performed as follows, for example. First, the stator support is cooled to shrink the outer diameter of the stator support. Next, the stator support is inserted through the through hole. Then, the temperature of the stator support is raised to the room temperature, thereby enlarging the outer diameter of the stator support compared to its size during cooling. This causes the stator support to apply pressure to the stator inner peripheral surface, and the stator is fixed to the stator support.

One embodiment may include the following features in addition to or in place of at least any one of the Features 1 through 26:
Feature 27: the first fixing mode includes bonding with an adhesive.

In the electric work machine including at least Features 1 through 22 and 27, the stator can be fixed, (i) without deforming the inner peripheral surface of the stator support, (ii) easily and (iii) stably, to the stator support.

The adhesive may be in any form. For example, the adhesive may be in the form of an acrylic-based adhesive. More specifically, the adhesive may be in the form of a liquid mixture adhesive or a liquid anaerobic adhesive.

The adhesive may be applied to, may infiltrate, or may fill the stator support and/or the stator in any manner. For example, an adhesive may be firstly applied to the outer peripheral surface of the stator support. Then, the stator support may be inserted through the through hole of the stator. This causes the adhesive to infiltrate a space (hereinafter, referred to as an “infiltration space”) between the outer peripheral surface of the stator support and the inner peripheral surface of the through hole and the stator is fixed to the stator support by the adhesive. Specifically, the inner peripheral surface of the through hole is fixed to the outer peripheral surface of the stator support via the adhesive.

The first fixing mode may be a mode different from bonding by the adhesive.

One embodiment may include at least any one of the following features in addition to or in place of at least any one of the above Features 1 through 27.
Feature 28: the stator includes a stator inner peripheral surface corresponding to an inner peripheral surface of the through hole.
Feature 29: the stator support includes an outer peripheral surface facing the stator inner peripheral surface.
Feature 30: a first recess and/or a second recess.
Feature 31: the first recess is on the stator inner peripheral surface.
Feature 32: the first recess is filled with a first part of the adhesive.
Feature 33: the second recess is on the outer peripheral surface of the stator support.
Feature 34: the second recess is filled with a second part of the adhesive. The second part may be distinct from the first part.

In the electric work machine including at least Features 1 through 22 and 27 through 34, more adhesive can infiltrate the infiltration space (in particular, the first recess and/or the second recess). Thus, an appropriate amount of adhesive can infiltrate the infiltration space, and as a result, the stator can be stably fixed to the stator support.

One embodiment may include at least the first recess.

One embodiment may include at least any one of the following features in addition to or in place of at least any one of the above Features 1 through 34.
Feature 35: the through hole includes an opening from which the shaft protrudes.
Feature 36: the first recess extends, on the stator inner peripheral surface, from the opening along a rotational axis of the shaft.

In the electric work machine including at least Features 1 through 22, 27 through 36, more adhesive can infiltrate the infiltration space over a longer range along the axial direction. This allows the stator to be stably fixed to the stator base.

One embodiment may include at least any one of the following features in addition to or in place of at least any one of the above Features 1 through 36.
Feature 37: the stator inner peripheral surface includes a first flat region (or a first flat surface).
Feature 38: the outer peripheral surface of the stator support includes a second flat region (or a second flat surface).
Feature 39: the second flat region faces the first flat region.

In the electric work machine including at least Features 1 through 22, 28, 29, and 37 through 39, it is possible to inhibit the stator from rotating relative to the stator support.

A part or all of the second flat region may face the first flat region. A part or all of the second flat region may be in contact with the first flat region. The second flat region may be directly or indirectly in contact with the first flat region (e.g., via an adhesive).

The stator inner peripheral surface may include the first flat region and a first curved region. The first curved region may be a part or all of the region on the stator inner peripheral surface excluding the first flat region. The outer peripheral surface of the stator support may include the second flat region and a second curved region. The second curved region may be a part or all of the region on the outer peripheral surface excluding the second flat region.

One embodiment may include at least any one of the following features in addition to or in place of at least any one of the above Features 1 through 39.
Feature 40: a second bearing that is distinct from the first bearing.
Feature 41: the second bearing is fixed to the stator support inside (e.g., in a hollow portion of, or an internal space of) the stator support.
Feature 42: the second bearing rotatably supports the shaft.

In the electric work machine including at least Features 1 through 22, and 40 through 42, the shaft can be stably supported.

One embodiment may include at least any one of the following features in addition to or in place of at least any one of the above Features 1 through 42.
Feature 43: the first bearing at least partially overlaps with the stator in a view taken along a specified direction.
Feature 44: the specified direction is perpendicular to the rotational axis of the shaft.

In other words, Feature 43 means that, in the axial direction, a first bearing arrangement area at least partially overlaps with a stator arrangement area. In other words, the first bearing and the stator face each other directly or indirectly, at least partially in the specified direction.
Feature 45: the second bearing does not overlap with the stator in the view taken along the specified direction. That is, in the axial direction, a second bearing arrangement area does not overlap with the stator arrangement area. In other words, the second bearing and the stator do not face each other directly or indirectly in the specified direction. No portion of the second bearing is required to overlap with the stator in the view taken along the specified direction.

In the electric work machine including at least Features 1 through 22, and 40 through 45, the first bearing is arranged close to the stator. This allows for downsizing of the outer rotor motor, and consequently, allows for downsizing of the electric work machine.

One embodiment may include at least any one of the following features in addition to or in place of at least any one of the above Features 1 through 45.
Feature 46: the shaft includes a first surface in contact with the first bearing.
Feature 47: the shaft includes a second surface in contact with the second bearing.
Feature 48: a length of the first surface in the axial direction is greater than a length of the second surface in the axial direction.

In the electric work machine including at least Features 1 through 22 and 40 through 48, the shaft can be stably supported by the first bearing.

One embodiment may include the following features in addition to or in place of at least any one of the Features 1 through 48.
Feature 49: the first bearing is in the form of a needle roller bearing.

In the electric work machine including at least Features 1 through 22 and 49, it is possible to inhibit the upsizing of the first bearing. This allows for downsizing of the outer rotor motor, and consequently, allows for downsizing of the electric work machine.

The first bearing may be in the form that is different from the needle roller bearing. For example, the first bearing may be a roller bearing in the form that is different from the needle roller bearing. For example, the first bearing may be a rolling bearing (e.g., a ball bearing) that is different from the roller bearing. The first bearing may be in the form different from the rolling bearing (e.g., in the form of a plain bearing).

The second bearing may be in any form. The second bearing may be in the form of a rolling bearing. Specifically, the second bearing may be, for example, a ball bearing or a roller bearing. The second bearing may be in the form (e.g., in the form of a plain bearing) different from the rolling bearing.

One embodiment may include at least any one of the following features in addition to or in place of at least any one of the above Features 1 through 49.
Feature 50: a housing that accommodates the outer rotor motor.
Feature 51: a mounting part (or a mounting portion, or an attachment portion) directly or indirectly fixing the stator support to the housing.

In the electric work machine including at least Features 1 through 22, 50, and 51, the outer rotor motor can be stably fixed to the housing.

One embodiment may include the following features in addition to or in place of at least any one of the Features 1 through 51.
Feature 52: the mounting part is integrally formed with the stator support.

In the electric work machine including at least Features 1 through 22 and 50 through 52, the outer rotor motor can be efficiently fixed to the housing.

One embodiment may include at least any one of the following features in addition to or in place of at least any one of the Features 1 through 52.
Feature 53: the stator support includes an aluminum alloy.
Feature 54: in the stator, at least a part including the through hole includes electromagnetic steel (or an electromagnetic steel plate).

In the electric work machine including at least Features 1 through 22, 53, and 54, it is possible to reduce the weight of the stator support (and consequently reduce the weight of the outer rotor motor).

If the stator support (including an aluminum alloy) is press-fitted into the through hole of the stator (including electromagnetic steel), the outer peripheral surface of the stator support may be damaged by pressure from the stator. Thus, it is not easy to use an aluminum alloy as a material for the stator support in a case where the stator support is press-fitted into the stator.

However, in this disclosure, the stator is fixed to the stator support using the first fixing mode. Thus, damage to the stator support is inhibited or prevented when the stator is fixed to the stator support. Accordingly, the aluminum alloy can be easily used as a material for the stator support, allowing for weight reduction in the outer rotor motor.

The stator support may include any amount of aluminum alloy. The aluminum alloy may contain any amount of aluminum.

The stator support may include a metal (or a non-ferrous metal) different from the aluminum alloy.

The stator may include a stator core. The “at least a part including the through hole” may correspond to the stator core. That is, the stator core may include the through hole. At least a part or all of the stator core may include electromagnetic steel (or an electromagnetic steel plate). The stator core may be formed of stacked electromagnetic steel plates. The stator core may include a magnetic material (for example, a soft magnetic material) distinct from the electromagnetic steel.

The stator core may include a core back (or a yoke). The core back may have a substantially cylindrical shape. The stator core may include teeth. The teeth may radially extend from the outer periphery of the core back. The stator may include a plurality of coils. The coils may be wound around the respective teeth. The core back and the teeth may be integrally formed from electromagnetic steel.

The stator may include an insulator. The insulator may at least partially cover the stator core. The insulator may at least partially cover the teeth. The insulator may cover a portion of the teeth where the coil is wound.

One embodiment may provide an electric work machine (or a power tool or an electric machinery or an on-site equipment) including at least any one of the Features 1 through 11 and 22, and the following Features 55 through 57.
Feature 55: the stator support has a tubular shape.
Feature 56: the stator support is inserted into the through hole.
Feature 57: the stator support is bonded to the stator with an adhesive, thereby supporting the stator. In other words, the stator is adhered and fixed to the stator support by the adhesive.

In the electric work machine including at least features 1 through 11, 22, and 55 through 57, the stator can be properly fixed to the stator support.

One embodiment may provide a method including at least any one of the following features. This method is a method for manufacturing an outer rotor motor for use in (or to be mounted on) an electric work machine.
Feature 58: fixing a stator to a stator support by a specified fixing mode.
Feature 59: the fixing includes inserting the stator support into a through hole of the stator.
Feature 60: the stator support has a tubular shape. The stator support and the through hole may be formed to allow the shaft of the rotor to pass through (or penetrate) the stator support and the through hole.
Feature 61: the specified fixing mode is a mode in which a screw fastener is not used.
Feature 62: the specified fixing mode is a mode in which a specified deformation of the stator support does not occur.
Feature 63: the specified deformation includes a deformation of an inner peripheral surface of the stator support based on fixing the stator to the stator support. That is, the inner peripheral surface of the stator support does not deform by fixing the stator to the stator support.
Feature 64: fixing a bearing to the stator support by inserting the bearing inside the stator support.
Feature 65: the bearing is configured to rotatably support a shaft of the rotor.

According to the method including at least Features 58 through 65, the stator can be properly fixed to the stator support.

Examples of the outer rotor motor include a brushless motor (including a brushless DC motor and/or a brushless AC motor), a brushed DC motor, an AC motor, and a stepper motor.

Examples of the electric work machine include a variety of machinery configured to be used in a work site such as construction, manufacturing, gardening, and civil engineering; specifically, a power tool for stone processing, metal processing, and wood processing, a power tool for gardening, a power tool for organizing the environment of the work site, a fan vest, a fan jacket, a hand-cart wheel barrow, an electric assist bicycle, and an inflator.

Examples of the power tool include an electric chainsaw, an electric handy saw, an electric blower, an electric hammer, an electric hammer drill, an electric drill, an electric driver, an electric wrench, an electric impact driver, an electric impact wrench, an electric grinder, an electric circular saw, an electric reciprocating saw, an electric jigsaw, an electric cutter, an electric plane, an electric nailer (including a tacker), an electric hedge trimmer, an electric lawn mower, an electric lawn trimmer, an electric bush cutter, an electric cleaner, an electric sprayer, an electric spreader, an electric dust collector, an electric trowel, an electric vibrator, an electric rammer, an electric compactor, an electric pump, an electric pile driver, an electric concrete saw, an electric screed, and an electric cut-off saw.

The examples of the electric work machine may also be battery-operated devices configured to be driven by batteries. Specifically, the examples of the electric work machine may include a built-in battery and/or may be configured to detachably attach a battery pack. The battery pack houses a battery.

In one embodiment, the Features 1 through 65 may be combined in any combinations.

In one embodiment, any of the Features 1 through 65 may be excluded.

### 2. Specific Exemplary Embodiment

Hereinafter, a specific example embodiment is described. This specific embodiment provides an electric work machine 1 in the form of an electric chainsaw. However, such an electric work machine 1 is merely an example, and this disclosure is applicable to electric work machines of any form.

### [2-1. Entire Configuration of Electric Work Machine]

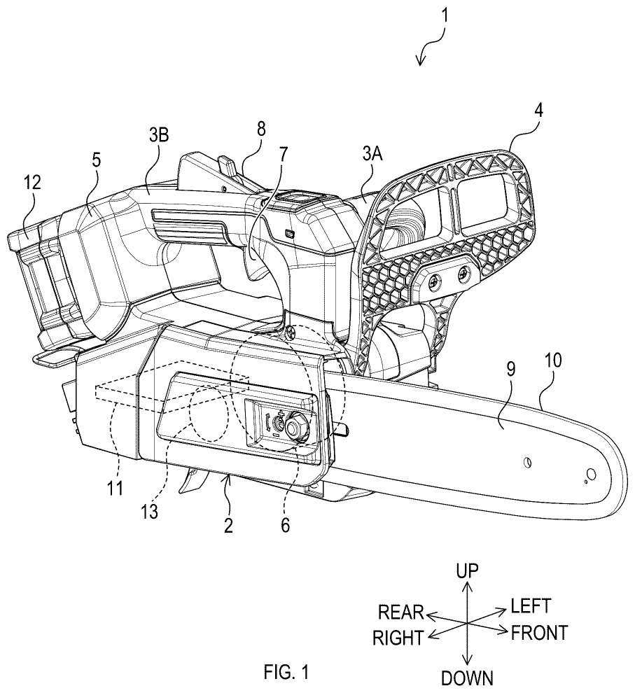

As shown in FIG. 1, an electric work machine 1 includes a housing 2.

The housing 2 is made of a synthetic resin. The housing 2 accommodates an outer rotor motor (hereinafter referred to as a “motor”) 6. The housing 2 accommodates a controller 11.

For the purpose of explanation, in the present embodiment, the directions “up,” “down,” “right,” “left,” “front,” and “rear” are defined with respect to the electric work machine 1 positioned at the center as shown in FIG. 1 and the subsequent figures.

The electric work machine 1 includes a guide bar 9. The guide bar 9 is a plate-shaped member. The guide bar 9 protrudes forward from the housing 2.

The electric work machine 1 includes a saw chain (or a driven tool) 10. The saw chain 10 includes a plurality of cutters connected to each other. The saw chain 10 is detachably attached to a peripheral edge of the guide bar 9.

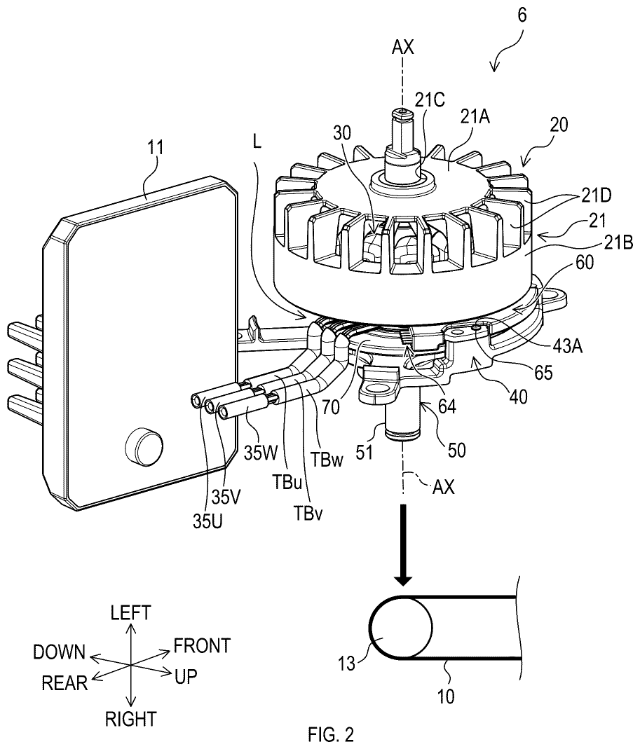

The electric work machine 1 includes a power transmitting device 13. The power transmitting device 13 is directly or indirectly coupled to a rotor shaft 50 (see FIG. 2) of the motor 6. The saw chain 10 is coupled to the motor 6 through the power transmitting device 13. The power transmitting device 13 includes a sprocket (not shown) configured to receive the saw chain 10 attached thereto. The power transmitting device 13 transmits a rotation of the motor 6 (specifically, a rotation of the rotor shaft 50) to the saw chain 10, thereby driving the saw chain 10.

In response to the motor 6 being driven, the saw chain 10 moves along the peripheral edge of the guide bar 9. The electric work machine 1 can cut a workpiece by the moving saw chain 10.

The electric work machine 1 includes a battery port (or a battery-mounting part) 5. The battery port 5 of the present embodiment protrudes upward from the rear of the housing 2. A battery pack 12 is detachably attached to the battery port 5. The battery pack 12 is mountable on a rear end face of the battery port 5. The battery pack 12 includes a rechargeable battery. Examples of the rechargeable battery includes a rechargeable lithium-ion battery. The battery pack 12 is mounted on the battery port 5, thereby supplying an electric power to the electric work machine 1. The motor 6 is driven by receiving the electric power from the battery pack 12 via the controller 11.

The electric work machine 1 includes a hand guard 4. The hand guard 4 protrudes upward from the front of the housing 2.

The electric work machine 1 includes a side handle 3A and a top handle 3B behind the hand guard 4. Either the side handle 3A or the top handle 3B may be omitted. The side handle 3A and the top handle 3B are made of a synthetic resin.

The side handle 3A is a pipe-shaped member. The side handle 3A protrudes leftward from the left of the housing 2. A user (or a worker) of the electric work machine 1 can grip the side handle 3A with the left hand from the rear of the electric work machine 1.

The top handle 3B protrudes upward from the top of the housing 2. The rear end of the top handle 3B is connected to the battery port 5, and there is a space between the top handle 3B and the housing 2. The user can insert his or her fingers into this space to grip the top handle 3B.

The electric work machine 1 includes a trigger switch 7 below the top handle 3B. The trigger switch 7 is operated (i.e., pulled) by the user to drive the motor 6. In response to the trigger switch 7 being pulled upward, the motor 6 is driven. In response to the trigger switch 7 being released, the motor 6 is stopped.

The electric work machine 1 includes a trigger lock lever 8 above the top handle 3B. The trigger lock lever 8 is pressed downward by the user, allowing the trigger switch 7 to be operated.

Hereinafter, a specific configuration of the motor 6 are described with reference to FIGS. 2 through 6.

### [2-2. Specific Configuration of Motor]

The motor 6 of the present embodiment is in the form of a brushless motor (or a brushless DC motor), and more specifically, an outer-rotor brushless motor.

As shown in FIGS. 2 through 6, the motor 6 includes a rotor 20. The motor 6 includes a stator 30.

The rotor 20 is disposed outside the stator 30 and rotates around the stator 30.

The motor 6 includes a rotor shaft 50. The rotor shaft 50 is fixed to the rotor 20. The central axis of the rotor shaft 50 coincides with a rotational axis AX of the motor 6. Thus, the rotor 20 and the rotor shaft 50 rotate around the rotational axis AX.

The motor 6 includes a sensor board 60. The sensor board 60 includes three magnetic sensors 62. The three magnetic sensors 62 are configured to detect a rotation of the rotor 20.

The motor 6 includes a stator base 40. The stator base 40 supports the stator 30 and the sensor board 60.

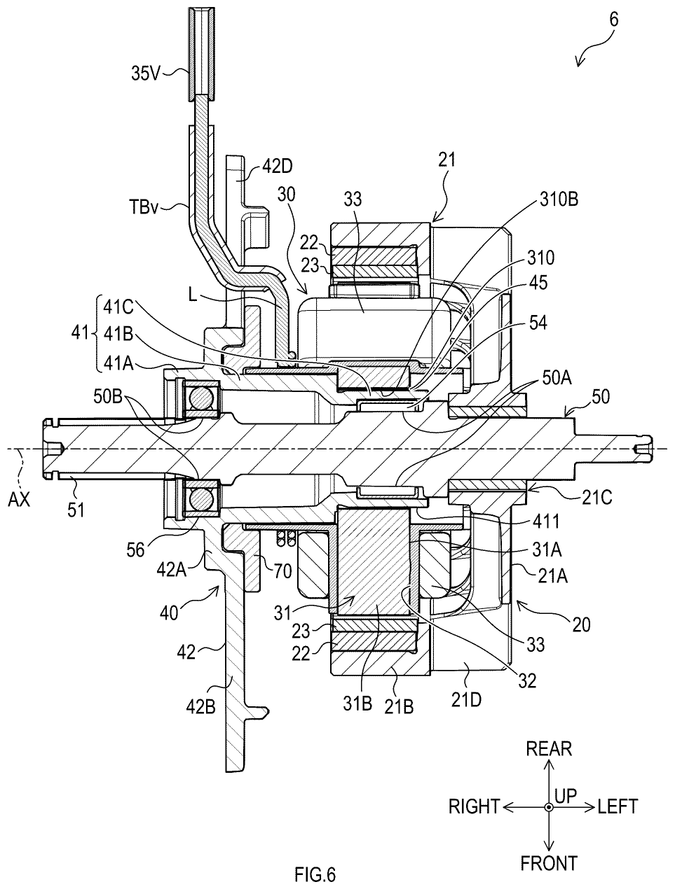

The motor 6 includes an insulating member 70 between the stator base 40 and the stator 30. The insulating member 70 has a hollow circular plate shape. The insulating member 70 includes an inner hole. A second support 41B described below is inserted into the inner hole (see FIG. 6).

The rotor shaft 50 passes through the rotor 20, the stator 30, the insulating member 70, and the stator base 40. The rotor shaft 50 protrudes leftward from the rotor 20 and protrudes rightward from the stator base 40. The rotor shaft 50 includes an output shaft 51. The output shaft 51 corresponds to a part of the rotor shaft 50. The output shaft 51 includes a first end of the rotor shaft 50, protruding outward (rightward) from the stator base 40. The output shaft 51 is directly or indirectly coupled to the power transmitting device 13. The rotor shaft 50 drives the saw chain 10 via the power transmitting device 13.

Hereinafter, main components of the motor 6 including the rotor 20, the stator 30, and the stator base 40 are described in more detail with reference to FIGS. 1 through 6.

### [2-2-1. Rotor]

The rotor 20 includes a rotor cup 21. The rotor cup 21 has a cylindrical shape or a bowl shape and is open at its right end. The rotor cup 21 is made of metal. Specifically, the rotor cup 21 contains aluminum as a main component. Aluminum is non-magnetic.

The rotor cup 21 includes a plate portion 21A. The plate portion 21A has an annular shape. The plate portion 21A includes an opening 21C at its center. The rotor shaft 50 is (i) inserted into the opening 21C, and (ii) fixed to the rotor cup 21. The rotor shaft 50 may be fixed to the rotor cup 21 by any method. In this embodiment, the rotor shaft 50 is press-fitted into the opening 21C and is thereby fixed to the opening 21C (and thus to the rotor cup 21).

The rotor cup 21 includes a yoke portion 21B. The yoke portion 21B has a cylindrical shape. The yoke portion 21B surrounds the rotor shaft 50.

The rotor cup 21 includes a plurality of fins 21D between the plate portion 21A and the yoke portion 21B. The yoke portion 21B is connected to an outer peripheral edge of the plate portion 21A via the fins 21D. The fins 21D are arranged at equal intervals along an outer periphery of the plate portion 21A. The fins 21D rotate together with the plate portion 21A (i.e., the rotor 20), thereby generating air flow. The air flow cools the motor 6.

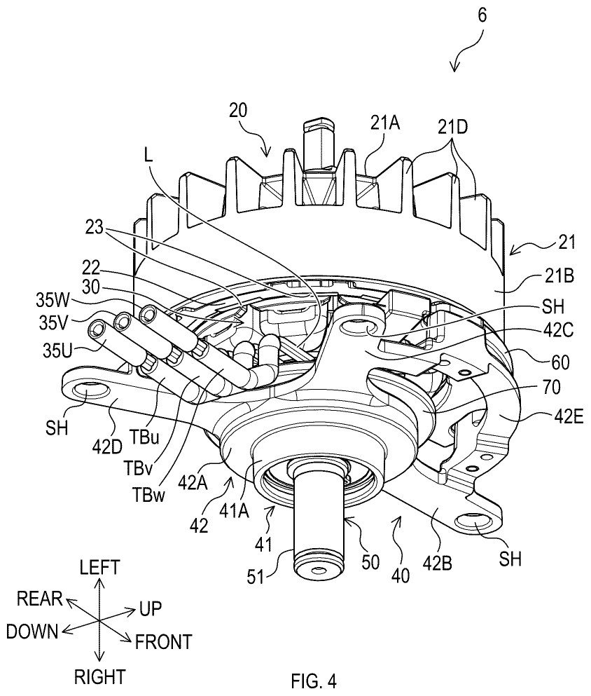

As shown in FIGS. 4 through 6, the rotor 20 includes a rotor core 22. The rotor core 22 includes steel plates (or steel sheets) laminated in a direction along the rotational axis AX (hereinafter referred to as an “axial direction”). The rotor core 22 has a substantially cylindrical shape. The rotor core 22 is supported by an inner peripheral surface of the yoke portion 21B of the rotor cup 21.

As shown in FIGS. 4 through 6, the rotor 20 includes a plurality of magnets 23. Each of the magnets 23 is a permanent magnet. Each of the magnets 23 has a plate shape. Each of the magnets 23 is in the form of a sintered magnet in the present embodiment. The magnets 23 are arranged in an inner peripheral surface of the rotor core 22. Specifically, the magnets 23 are arranged at intervals along a circumferential direction of the rotor core 22. Each of the magnets 23 is fixed to the inner peripheral surface of the rotor core 22, for example, by an adhesive. In this embodiment, the magnets 23 consist of twelve magnets 23. Each of the magnets 23 has a magnet surface facing the rotational axis AX. The magnet surface has a magnetic pole (an N pole or an S pole). The magnets 23 are arranged so that the N pole and the S pole appear alternately along the circumferential direction.

### [2-2-2. Stator]

The stator 30 is disposed within the rotor core 22. That is, the stator 30 is arranged to face the magnets 23 in a radial direction. The radial direction is perpendicular to the rotational axis AX. In other words, the rotor 20 surrounds or houses the stator 30.

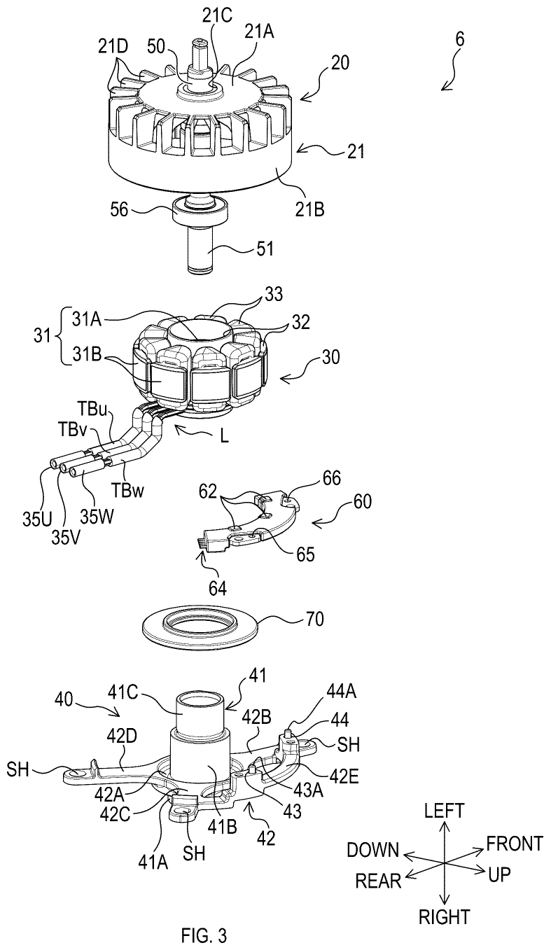

As shown in FIGS. 3, 5, and 6, the stator 30 includes a stator core 31. The stator core 31 is made of electromagnetic steel. The stator core 31 includes steel plates (or steel sheets) laminated along the axial direction.

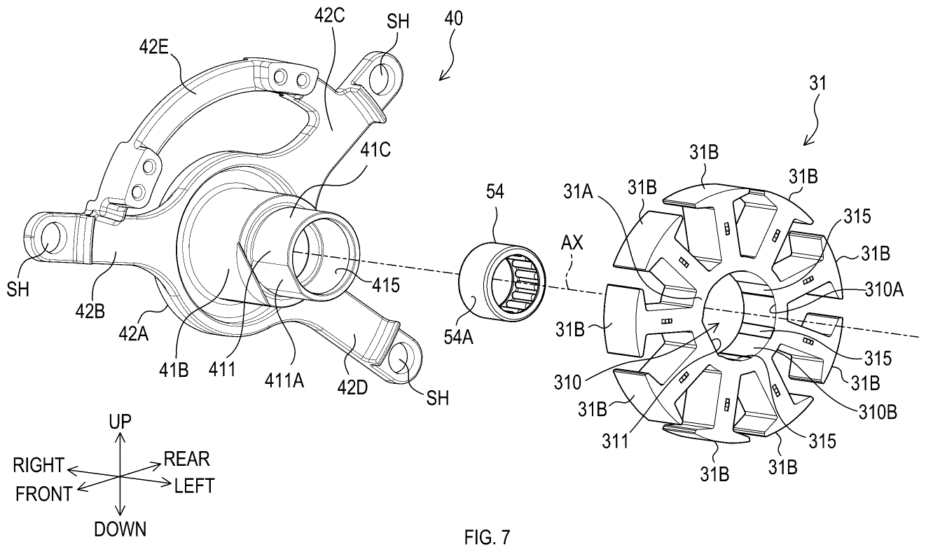

The stator core 31 includes a yoke (or a stator back) 31A. The yoke 31A has a tubular shape (e.g., a cylindrical shape). Specifically, the yoke 31A includes a through hole (or a central bore) 310 as shown in FIG. 6. The stator base 40 is inserted into this through hole 310, and the rotor shaft 50 is inserted into the stator base 40. That is, the rotor shaft 50 passes through the through hole 310 via the stator base 40. A central axis of the yoke 31A (i.e., a central axis of the through hole 310) coincides with the rotational axis AX. The through hole 310 is described in detail below with reference to FIGS. 7 through 9.

The stator core 31 includes teeth 31B. The teeth 31B protrudes radially outward from the yoke 31A. The teeth 31B are arranged at intervals along the circumferential direction. The teeth 31B are integrally formed with the yoke 31A. In this embodiment, the teeth 31B consist of nine teeth 31B. A slot is formed between two teeth 31B that are adjacent to each other along the circumferential direction. That is, the motor 6 of the present embodiment is in the form of a brushless motor with twelve poles and nine slots.

As shown in FIGS. 3, 5, and 6, the stator 30 includes an insulator 32. The insulator 32 is made of, for example, a synthetic resin. The insulator 32 covers at least a part of the surface of the stator core 31.

As shown in FIGS. 3, 5, and 6, the stator 30 includes a plurality of coils 33. Each of the coils 33 includes a wire. Each of the teeth 31B includes a coil attachment surface. The wire of one of the coils 33, corresponding to one of the teeth 31B, is wound around the coil attachment surface of the corresponding tooth 31B. The insulator 32 covers both the coil attachment surface of each of the teeth 31B and an outer peripheral surface of the yoke 31A. The outer peripheral surface of the yoke 31A is in contact with the wires of the coils 33. Thus, the stator core 31 is insulated from the coils 33 by the insulator 32.

In this embodiment, the stator core 31 and the insulator 32 are integrally formed. The insulator 32 may be fixed to the stator core 31 by insert molding. Specifically, the stator core 31 and the insulator 32 may be formed as described below. First, the stator core 31 is placed in a mold. Next, a heated and melted synthetic resin is injected into the mold. The synthetic resin is solidified and integrated (i.e., fixed) with the stator core 31 to form the insulator 32.

The coils 33 are provided to the teeth 31B, respectively. That is, in the present embodiment, the coils 33 consist of nine coils 33. The wire of the coil 33 corresponding to each tooth 31B is wound around the tooth 31B. The number of the coils 33 is equal to the number of the teeth 31B. Each of the teeth 31B includes a tooth outer peripheral surface. The tooth outer peripheral surface is a surface facing radially outward. In each of the teeth 31B, the coil attachment surface is covered by the insulator 32, but the tooth outer peripheral surface is not covered by the insulator 32.

### [2-2-3. Bearing]

The motor 6 includes a plurality of bearings. The rotor shaft 50 passes through the bearings. The bearings rotatably support the rotor shaft 50 (and thus, the rotor 20).

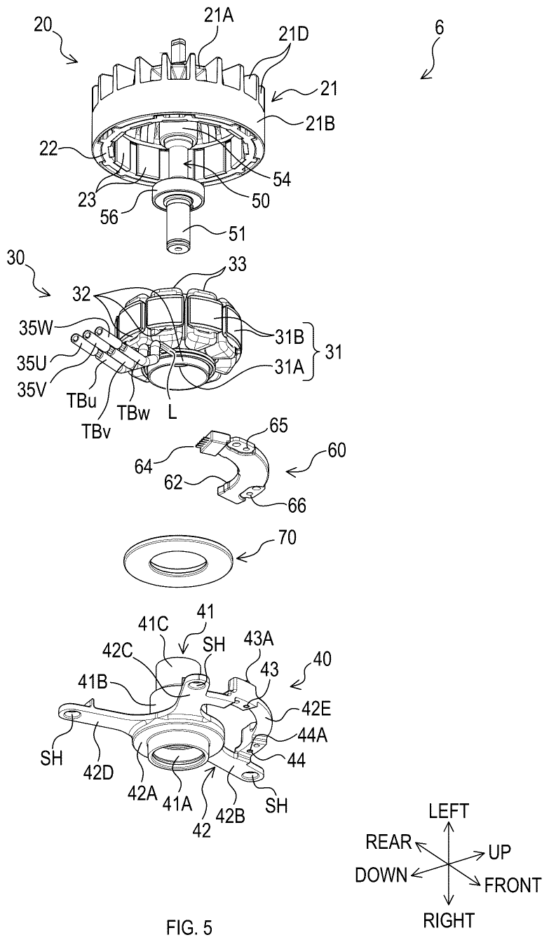

In this embodiment, the bearings include a first bearing 54 (see FIGS. 5 and 6) and a second bearing 56 (see FIGS. 3, 5, and 6). The first bearing 54 and the second bearing 56 are fitted into the stator base 40. Specifically, the first bearing 54 is fitted into a third support 41C described below (see FIGS. 3, 5, and 6). The second bearing 56 is fitted into a first support 41A described below (see FIGS. 3 through 6).

In this embodiment, the first bearing 54 is in the form of a roller bearing (specifically, a radial roller bearing, and more specifically, a needle roller bearing), and the second bearing 56 is in the form of a ball bearing (more specifically, a radial ball bearing).

As shown in FIG. 6, the rotor shaft 50 includes a first surface 50A. The first surface 50A corresponds to a region of the surface of the rotor shaft 50 in contact with the first bearing 54. The rotor shaft 50 further includes a second surface 50B. The second surface 50B corresponds to a region of the surface of the rotor shaft 50 in contact with the second bearing 56.

In this embodiment, a length of the first surface 50A in the axial direction is greater than a length of the second surface 50B in the axial direction. However, the length of the first surface 50A may be equal to or less than the length of the second surface 50B.

### [2-2-4. Stator Base]

The stator base 40 of the present embodiment is made of aluminum. That is, the stator base 40 includes an aluminum alloy. The stator base 40 is integrally formed of an aluminum alloy in the present embodiment.

As shown in FIGS. 3 through 6, the stator base 40 includes a stator support 41. The stator support 41 (i) has a tubular shape and (i) includes a plurality of steps along the rotational axis AX. The rotor shaft 50 passes through this stator support 41 in the axial direction.

The stator support 41 includes the first support 41A, the second support 41B, and the third support 41C. The first support 41A, the second support 41B and the third support 41C each have a tubular shape. The first support 41A is connected to the second support 41B along the rotational axis AX. The second support 41B is connected to the third support 41C along the rotational axis AX. An outer diameter of the second support 41B is greater than an outer diameter of the third support 41C. An outer diameter of the first support 41A is greater than the outer diameter of the second support 41B.

The second bearing 56 is fitted into a hollow portion of the first support 41A. That is, the first support 41A (specifically, its hollow portion) has an inner diameter that allows the second bearing 56 to be fitted into the hollow portion. The second support 41B is fitted into a hollow portion of the insulator 32. That is, the second support 41B has an outer diameter that allows the second support 41B to be fitted into the hollow portion of the insulator 32. The outer diameter of the second support 41B is greater than an inner diameter of a hollow portion of the stator core 31 (specifically, a hollow portion of the yoke 31A). The first bearing 54 is fitted into a hollow portion of the third support 41C. That is, the third support 41C (specifically, its hollow portion) has an inner diameter that allows the first bearing 54 to be fitted into the hollow portion. Furthermore, the third support 41C has the outer diameter that allows the third support 41C to be inserted into the hollow portion of the stator core 31.

FIGS. 3 and 5 show a state in which the rotor shaft 50 is inserted into the first and second bearings 54 and 56. However, practically, the first and second bearings 54 and 56 are fixed inside the stator base 40 first as described below. Then, the rotor shaft 50 is inserted into the stator base 40 and thereby supported by the first and second bearings 54 and 56.

As shown in FIG. 6, the stator support 41 is inserted into the through hole 310 of the stator core 31. More specifically, the third support 41C is inserted into the through hole 310.

The stator core 31 is fixed to the third support 41C by a first fixing mode (or a first fixing manner or a first fixing method) and thereby supported by the stator support 41 (thus the stator base 40).

The first fixing mode is a fixing mode in which a screw fastener is not used. The screw fastener has a screw groove (or a screw thread) formed in a spiral shape. Examples of the screw fastener include various screws, bolts, and nuts.

The first fixing mode is a mode in which the third support 41C undergoes little or no first deformation. That is, in the first mode, little or no first deformation occurs in the third support 41C. The first deformation includes a deformation of a base inner peripheral surface 415 (see FIG. 7) based on fixing (or having fixed) the stator core 31 to the third support 41C. The base inner peripheral surface 415 is an inner peripheral surface of the third support 41C. The first deformation may be a deformation from an initial state. The initial state is a state (or a shape) of the third support 41C before the stator core 31 is attached to the third support 41C.

That is, in the present embodiment, during a step in which the stator core 31 is placed around the third support 41C and fixed to the third support 41C, little or no deformation of the base inner peripheral surface 415 occurs due to the insertion and/or the fixing. During the step and/or in a state where the stator core 31 is fixed to the third support 41C, the third support 41C may receive (or may have received) pressure from the stator core 31. However, at least the base inner peripheral surface 415 does not deform, or hardly deforms, depending on the pressure. In other words, the base inner peripheral surface 415 undergoes little or no deformation due to the pressure.

The first fixing mode includes bonding with an adhesive 45 (see FIG. 6) in the present embodiment. That is, in the present embodiment, the stator core 31 is adhered and fixed to the third support 41C (and thus, to the stator base 40) by the adhesive 45. As shown in FIG. 6 (as shown in detail in FIG. 7), the third support 41C includes a base outer peripheral surface 411, and the through hole 310 of the stator core 31 includes a stator inner peripheral surface 310B. The adhesive 45 is filled in a space between the base outer peripheral surface 411 and the stator inner peripheral surface 310B.

Each of the first and second bearings 54 and 56 may be fixed to the stator base 40 in any manner.

In this embodiment, the first bearing 54 is fixed to the third support 41C by a second fixing mode. The second fixing mode is a mode in which the third support 41C undergoes a second deformation. That is, in the second fixing mode, the second deformation occurs (or may occur) in the third support 41C. The second deformation includes a deformation of the third support 41C based on fixing (or having fixed) the first bearing 54 to the third support 41C. The second deformation may be a deformation from the initial state. That is, in the present embodiment, during a step in which the first bearing 54 is fitted into the hollow portion of the third support 41C and fixed to the third support 41C, the deformation of the third support 41C occurs or may occur due to the fitting and/or the fixing. During the step and/or in a state where the first bearing 54 is fixed to the third support 41C, the inner peripheral surface of the third support 41C may receive (or may have received) pressure from the first bearing 54. The third support 41C deforms (or has deformed) from the initial state due to the pressure.

The second fixing mode includes a press-fit in the present embodiment. That is, the first bearing 54 is press-fitted into the hollow portion of the third support 41C and is thereby fixed to the third support 41C.

The second bearing 56 is also press-fitted into the first support 41A in the present embodiment.

However, the first bearing 54 may be fixed to the third support 41C by a method other than the press-fit. The first bearing 54 may be fixed to the third support 41C by a method of, for example, a shrink fit, a freezing fit, or other methods. The same applies to the second bearing 56.

The first bearing 54 at least partially overlaps with the stator core 31 and the rotor core 22 in the axial direction. The second bearing 56 does not overlap with the stator 30 and the rotor core 22 in the axial direction.

When the motor 6 is assembled, the first bearing 54 and the second bearing 56 are fixed in the hollow portion of the stator base 40. Then, the rotor shaft 50 is inserted through the first bearing 54 and the second bearing 56 in this order. The rotor shaft 50 is thereby supported by the stator base 40 (specifically, by the first and second bearings 54 and 56). Therefore, the output shaft 51 of the motor 6 is supported by the first support 41A so as to be rotatable around the rotational axis AX.

As shown in FIGS. 3 through 6, the stator base 40 includes a mounting part 42. The mounting part 42 is integrally formed with the stator support 41. The mounting part 42 includes a mounting part main body 42A. The mounting part main body 42A has a hollow circular plate shape. The mounting part main body 42A is provided to an outer peripheral portion of the first support 41A.

The mounting part 42 includes a first mounting portion 42B, a second mounting portion 42C, and a third mounting portion 42D. Any one or two of the first mounting portion 42B, the second mounting portion 42C, and the third mounting portion 42D may be omitted.

The first mounting portion 42B, the second mounting portion 42C, and the third mounting portion 42D each protrude radially outward from the mounting part main body 42A. The first mounting portion 42B, the second mounting portion 42C, and the third mounting portion 42D each include a hole SH at their leading end portions. The leading end portions correspond to end portions opposite the mounting part main body 42A. A screw (not shown) is inserted into each hole SH. Each screw is screwed into a screw hole (not shown) provided on an inner surface of the housing 2, and the mounting part 42 (and thus, the motor 6) is thereby fixed to the housing 2. The mounting part 42 may be indirectly attached to the housing 2. That is, another object may be interposed between the mounting part 42 and the housing 2.

The stator base 40 includes a board fixing portion 42E between the first mounting portion 42B and the second mounting portion 42C. The board fixing portion 42E fixes the sensor board 60. The board fixing portion 42E has a shape corresponding to the shape of the sensor board 60, specifically, an arc shape centered on the rotational axis AX.

As shown in FIGS. 3 and 5, the board fixing portion 42E includes a first hole 43 and a first pin 43A at its first end. The first pin 43A is inserted into the first hole 43. Specifically, the first pin 43A is press-fitted into the first hole 43 in the present embodiment.

The board fixing portion 42E includes a second hole 44 and a second pin 44A in its second end. The second pin 44A is inserted into the second hole 44. Specifically, the second pin 44A is press-fitted into the second hole 44 in the present embodiment.

The first pin 43A is inserted into a third hole 65 in the sensor board 60. The second pin 44A is inserted into a fourth hole 66 in the sensor board 60. FIG. 2 shows a state in which the first pin 43A is inserted into the third hole 65. In this embodiment, the first pin 43A and the second pin 44A are fitted into the third hole 65 and the fourth hole 66, respectively by a clearance-fit. The sensor board 60 is positioned at a specified position with respect to the stator base 40 (and thus, with respect to the stator 30) by the first pin 43A and the second pin 44A.

### [2-2-5. Sensor Board]

The sensor board 60 includes three magnetic sensors 62 mounted on the sensor board 60. The three magnetic sensors 62 detect a rotational position of the rotor 20. Specifically, each of the three magnetic sensors 62 detects a change in the magnetic field caused by the rotation of the rotor 20 and outputs a detection signal according to the detected change. The sensor board 60 is supported by the stator base 40. Each of the three magnetic sensors 62 faces the corresponding magnets 23 in the axial direction. The sensor board 60 is positioned radially outward relative to the coils 33.

The sensor board 60 includes a connection terminal 64. The connection terminal 64 is electrically coupled to the three magnetic sensors 62. The connection terminal 64 is further electrically coupled to the controller 11 via a wiring (not shown). The connection terminal 64 electrically couples the three magnetic sensors 62 to the controller 11. The sensor board 60 includes the third hole 65 and the fourth hole 66.

### [2-3. Fixing of Stator to Stator Base]

With reference to FIGS. 7 through 9, a method of fixing the stator 30 to the stator base 40 is described in more detail. For simplicity and ease of understanding, only the stator core 31 of the stator 30 is extracted and illustrated in FIGS. 7 through 9.

As shown in FIG. 7, in the stator base 40, the third support 41C includes the base inner peripheral surface 415. When the first bearing 54 is press-fitted into the hollow portion of the third support 41C, the outer peripheral surface 54A of the first bearing 54 is pressed against the base inner peripheral surface 415. The first bearing 54 is thereby fixed to the third support 41C.

The base outer peripheral surface 411 is inserted into the through hole 310 of the stator core 31, and faces the stator inner peripheral surface 310B.

The base outer peripheral surface 411 includes an outer peripheral flat region 411A. The outer peripheral flat region 411A is one example of the second flat region in the overview of the embodiment. The base outer peripheral surface 411 is curved overall, but the outer peripheral flat region 411A is flat. The outer peripheral flat region 411A corresponds to a part of the base outer peripheral surface 411.

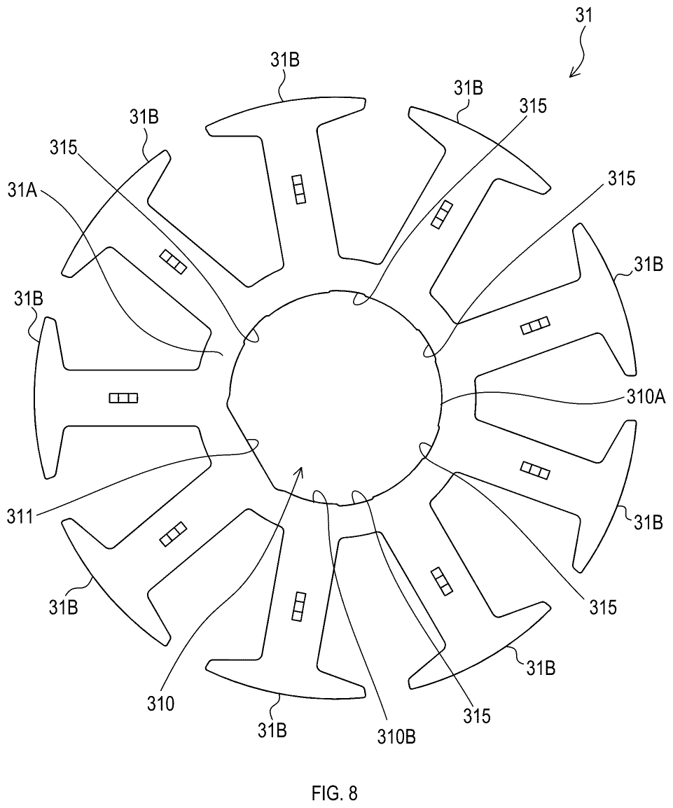

As shown in FIGS. 7 and 8, the through hole 310 of the stator core 31 includes an opening 310A. The third support 41C and the rotor shaft 50 protrude leftward from this opening 310A (see FIG. 6).

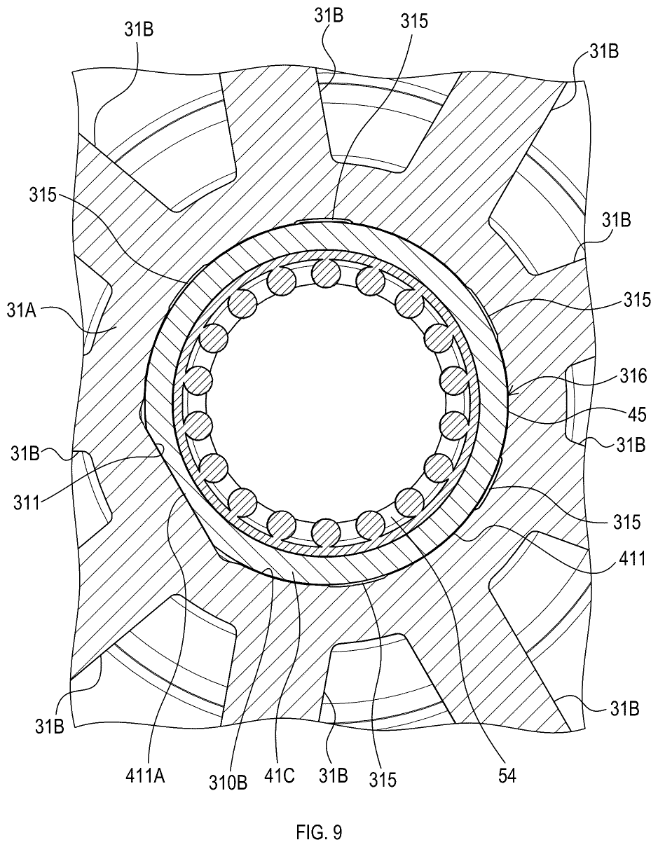

The through hole 310 includes an inner peripheral flat region 311 on the stator inner peripheral surface 310B. The inner peripheral flat region 311 is one example of the first flat region in the overview of the embodiment. The third support 41C is inserted into the through hole 310 so that the outer peripheral flat region 411A faces the inner peripheral flat region 311 (see FIG. 9). The outer peripheral flat region 411A is at least partially in contact with the inner peripheral flat region 311. The third support 41C is inserted into the through hole 310 in this way and fixed to the stator core 31, thereby restricting a movement of the stator core 31 relative to the stator base 40 in the circumferential direction.

The through hole 310 includes a plurality of recesses 315 on the stator inner peripheral surface 310B. Each of the recesses 315 extends from the opening 310A to an opening on the right along the rotational axis AX.

In this embodiment, the through hole 310 includes five recesses 315. However, the through hole 310 may include any number of recesses 315. The through hole 310 may include one or more recesses 315. The through hole 310 does not necessarily include the recess 315.

As shown in FIG. 9, the motor 6 includes a slight clearance 316 between the stator inner peripheral surface 310B and the base outer peripheral surface 411. The clearance 316 includes the recesses 315. The adhesive 45 is filled in this clearance 316 and the stator core 31 is thereby fixed to the third support 41C.

### [2-4. Electrical Configuration]

Next, an electrical configuration of the electric work machine 1 is briefly described. In this embodiment, the nine coils 33 are coupled to each other in delta configuration. The nine coils 33 include a first coil group, a second coil group and a third coil group. The first coil group includes three first coils 33 coupled in parallel to each other. The second coil group includes three second coils 33 coupled in parallel to each other. The third coil group includes three third coils 33 coupled in parallel to each other. The first through third coil groups are connected to each other in a delta configuration.

As shown in FIGS. 2 through 5, the motor 6 includes a lead group L. The lead group L of the present embodiment includes nine leads. The nine leads are coupled to the nine coils 33, respectively.

As shown in FIGS. 2 through 5, the motor 6 includes a first fusing terminal 35U, a second fusing terminal 35V, a third fusing terminal 35W, a first tube TBu, a second tube TBv. and a third tube TBw.

The nine leads are grouped into a U-phase wiring group, a V-phase wiring group, and a W-phase wiring group. The U-phase wiring group includes three of the nine leads corresponding to the U phase. The U-phase wiring group is coupled to the first fusing terminal 35U. The V-phase wiring group includes three of the nine leads corresponding to the V phase. The V-phase wiring group is coupled to the second fusing terminal 35V. The W-phase wiring group includes three of the nine leads corresponding to the W phase. The W-phase wiring group is coupled to the third fusing terminal 35W.

The U-phase wiring group is bundled together and inserted into the first tube TBu. The V-phase wiring group is bundled together and inserted into the second tube TBv. The W-phase wiring group is bundled together and inserted into the third tube TBw.

The first through third fusing terminals 35U, 35V, and 35W are electrically coupled to the controller 11. The controller 11 receives a battery power from the battery pack 12. The controller 11 converts the battery power into a three-phase electric power based on various information. The various information includes detection signals from the three magnetic sensors 62. The controller 11 delivers the three-phase electric power to the motor 6 via the first through third fusing terminals 35U, 35V, and 35W. The motor 6 is thereby driven.

### [2-5. Technical Effects in Embodiment]

According to the embodiment described above, the following technical effects are achieved.

The stator core 31 is fixed to the stator base 40 by the first fixing mode. Therefore, the stator core 31 can be properly fixed to the stator base 40. That is, it is possible to inhibit or prevent a deformation of the base inner peripheral surface 415 due to the fixing of the stator core 31 to the stator base 40. Therefore, the first bearing 54 can be accurately fixed to the stator base 40.

The stator core 31 is adhered and fixed to the stator base 40 by the adhesive 45. Therefore, it is possible to easily and stably fix the stator core 31 to the stator base 40.

On the other hand, the first and second bearings 54 and 56 are fixed to the stator base 40 by the second fixing mode. Specifically, the first and second bearings 54 and 56 are press-fitted into the hollow portion of the stator base 40 and are thereby fixed to stator base 40. Thus, it is possible to easily and firmly fix the first and second bearings 54 and 56.

On the stator inner peripheral surface 310B, the recesses 315 are formed. Thus, the clearance 316 for filling the adhesive 45 can be sufficiently ensured as necessary. This allows the stator core 31 to be more stably fixed to the stator base 40.

The stator base 40 is made of an aluminum alloy. As a result, it is possible to reduce the weight of the motor 6. In a manufacturing method in which the stator core 31 is fixed to the stator base 40 by press-fitting, it is difficult to use an aluminum alloy or other non-ferrous metals as a material for the stator base 40. However, in the present embodiment, the stator core 31 is adhered and fixed to the stator base 40. Thus, even if the stator base 40 is made of aluminum alloy, little or no damage is imparted to the stator base 40 by the stator core 31. Thus, the feature of the present embodiment in which the stator core 31 is adhered and fixed to the stator base 40 indirectly contributes to the weight reduction of the motor 6 as well.

[2-6. Correspondence between Terms]

The saw chain 10 corresponds to an example of the driven tool in the overview of the embodiment. The stator base 40 (specifically the stator support 41, more specifically the third support 41C) corresponds to an example of the stator support in the overview of the embodiment. The first bearing 54 corresponds to an example of the first bearing in the overview of the embodiment. The second bearing 56 corresponds to an example of the second bearing in the overview of the embodiment. The rotor shaft 50 corresponds to an example of the shaft in the overview of the embodiment. Each of the recesses 315 corresponds to one example of the first recess in the overview of the embodiment.

### [2-7. Other Embodiments]

The present disclosure is not limited to the above embodiment, but may be implemented in various forms.

In the embodiment, the recesses 315 are formed on the stator inner peripheral surface 310B. In place of or in addition to these recesses 315, one or more recesses may be formed on the base outer peripheral surface 411.

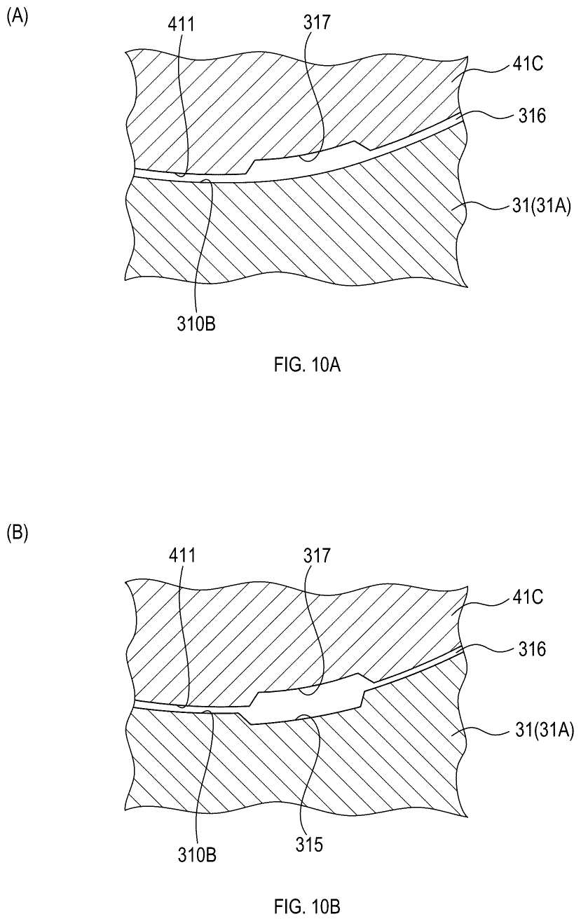

Specifically, as shown in FIG. 10A, one or more recesses 317 may be formed on the base outer peripheral surface 411 without forming the recess 315 on the stator core 31. The adhesive 45 may be filled in the clearance 316. The clearance 316 includes the one or more recesses 317. Each of the one or more recesses 317 corresponds to an example of the second recess in the overview of the embodiment.

Alternatively, as shown in FIG. 10B, the one or more recesses 317 may be formed on the base outer peripheral surface 411 in addition to the one or more recesses 315 of the stator core 31. In this case, the clearance 316 includes the one or more recesses 315 and the one or more recesses 317. The adhesive 45 may be filled in this clearance 316.

In the embodiment, the stator core 31 is adhered and fixed to the stator base 40. However, the stator core 31 may be fixed to the stator base 40 by the first fixing mode that is different from the method of adhesive bonding. For example, the stator core 31 may be fixed to the stator base 40 using a component other than screws.

In the embodiment, the first bearing 54 is in the form of a needle roller bearing. However, the first bearing 54 may be in the form other than the needle roller bearing. The second bearing 56 may also be in the form other than the ball bearing.

The motor 6 of the embodiment is in the form of a brushless motor with twelve poles and nine slots. However, the motor 6 may have any number of magnetic poles (i.e., magnets 23) and may include any number of teeth (i.e., slots). The coils 33 may be coupled to each other in any connection method. The motor 6 may be a motor in the form other than the brushless motor.

The electric work machine 1 of the embodiment is in the form of an electric chain saw. However, the electric work machine 1 may be in the form other than the electric chain saw. Specifically, the electric work machine 1 may be any of the various types of devices described above that are designed for use in work sites such as do-it-yourself carpentry, manufacturing, gardening, and construction.

The electric work machine 1 may be configured to receive AC power from an AC power source to be driven, in place of or in addition to the battery pack 12.

### [2-8. Supplementary Information]

Two or more functions of one element of the above-described embodiment may be achieved by two or more elements, and one function of one element may be achieved by two or more elements. Furthermore, two or more functions of two or more elements may be achieved by one element, and one function achieved by two or more elements may be achieved by one element. A part of the configurations of the above-described embodiments may be omitted. Furthermore, at least a part of the configurations of the above-described embodiments may be added to or replaced by another configuration of the above-described embodiments.

What is claimed is:

1. An electric work machine comprising:
an outer rotor motor including
a rotor including a rotor core and a shaft, the rotor core having a tubular shape and including a magnet,
a stator (i) disposed within the rotor core and (ii) including a coil and a through hole, the shaft passing through the through hole,
a stator support (i) having a tubular shape including an inner peripheral surface, (ii) inserted into the through hole, and (iii) fixing the stator by a first fixing mode, thereby supporting the stator, the first fixing mode being a mode in which (i) a screw fastener is not used and (ii) the stator support does not undergo a first deformation, the first deformation including a deformation of the inner peripheral surface of the stator support based on the stator support fixing or having fixed the stator, and
a first bearing (i) that is fixed to the stator support inside the stator support and (ii) that rotatably supports the shaft; and
a power transmitting device configured to transmit a rotation of the rotor to a driven tool to thereby drive the driven tool.

2. The electric work machine according to claim 1, wherein
the first bearing is fixed to the stator support by a second fixing mode, and
the second fixing mode is a mode in which the stator support undergoes a second deformation, the second deformation including a deformation of the stator support based on the first bearing being fixed or having been fixed to the stator support.

3. The electric work machine according to claim 2, wherein
the second fixing mode includes a press-fit.

4. The electric work machine according to claim 1, wherein
the first fixing mode includes bonding with an adhesive.

5. The electric work machine according to claim 4, wherein
the stator includes a stator inner peripheral surface corresponding to an inner peripheral surface of the through hole,
the stator support includes an outer peripheral surface facing the stator inner peripheral surface, and
the electric work machine further includes
a first recess (i) that is on the stator inner peripheral surface and (ii) that is filled with a first part of the adhesive, and/or
a second recess (i) that is on the outer peripheral surface of the stator support and (ii) that is filled with a second part of the adhesive.

6. The electric work machine according to claim 5, including the first recess.

7. The electric work machine according to claim 6, wherein
the through hole includes an opening from which the shaft protrudes, and
the first recess extends, on the stator inner peripheral surface, from the opening along a rotational axis of the shaft.

8. The electric work machine according to claim 1, wherein
the stator includes a stator inner peripheral surface corresponding to an inner peripheral surface of the through hole,
the stator support includes an outer peripheral surface facing the stator inner peripheral surface,
the stator inner peripheral surface includes a first flat region, and
the outer peripheral surface of the stator support includes a second flat region facing the first flat region.

9. The electric work machine according to claim 1, further including
a second bearing (i) that is distinct from the first bearing, (ii) that is fixed to the stator support inside the stator support, and (iii) that rotatably supports the shaft.

10. The electric work machine according to claim 9, wherein
in a view taken along a direction perpendicular to a rotational axis of the shaft, (i) the first bearing at least partially overlaps with the stator and (ii) the second bearing does not overlap with the stator.

11. The electric work machine according to claim 10, wherein
the shaft includes
a first surface in contact with the first bearing, and
a second surface in contact with the second bearing, and
a length of the first surface in the axial direction is greater than a length of the second surface in the axial direction.

12. The electric work machine according to claim 1, wherein
the first bearing is in the form of a needle roller bearing.

13. The electric work machine according to claim 1, further including
a housing that accommodates the outer rotor motor, and
a mounting part directly or indirectly fixing the stator support to the housing.

14. The electric work machine according to claim 13, wherein
the mounting part is integrally formed with the stator support.

15. The electric work machine according to claim 1, wherein
the stator support includes an aluminum alloy, and
at least a part of the stator, including the through hole, includes electromagnetic steel.

16. An electric work machine comprising:
an outer rotor motor including
a rotor including a rotor core and a shaft, the rotor core having a tubular shape and including a magnet,
a stator (i) disposed within the rotor core and (ii) including a coil and a through hole, the shaft passing through the through hole,
a stator support (i) having a tubular shape, (ii) inserted into the through hole, and (iii) bonded to the stator with an adhesive, thereby supporting the stator; and
a power transmitting device configured to transmit a rotation of the rotor to a driven tool to thereby drive the driven tool.

17. A method for manufacturing an outer rotor motor for use in an electric work machine, the method comprising:
fixing a stator to a stator support by a specified fixing mode, the fixing including inserting the stator support into a through hole of the stator, the stator support having a tubular shape, the specified fixing mode being a mode in which (i) a screw fastener is not used and (ii) a specified deformation of the stator support does not occur, and the specified deformation including a deformation of an inner peripheral surface of the stator support based on the stator being fixed to the stator support; and
fixing a bearing to the stator support by inserting the bearing inside the stator support, the bearing being configured to rotatably support a shaft of the rotor.
